(19) United States
(12) Patent Application Publication
(10) Pub. No.: US 2025/0274465 A1
(43) Pub. Date: Aug. 28, 2025

(54) TWO-STAGE ANOMALOUS DEVICE DETECTION

(71) Applicant: Palo Alto Networks, Inc., Santa Clara, CA (US)

(72) Inventors: Kanimozhi Kalaichelvan, San Jose, CA (US); Yilin Zhao, Sunnyvale, CA (US); Mei Wang, Saratoga, CA (US)

(21) Appl. No.: 18/588,860

(22) Filed: Feb. 27, 2024

(51) Int. Cl. H04L 9/40; H04L 41/16

(52) U.S. Cl. CPC H04L 63/1425; H04L 41/16

(57) ABSTRACT

An anomalous device detection service performs two-stage detection of anomalous devices in a network with verification of detected anomalies to reduce the incidence of false positive detections. The detection service generates a dual embedding for each device profile. The dual embedding comprises a sentence embedding and a character-based embedding that have been concatenated. The detection service clusters the dual embeddings and, from the resulting cluster(s), identifies outliers that correspond to candidate anomalous device profiles. The outliers are referred to as candidates at this stage because the detection service then verifies the verdicts of anomalousness resulting from clustering using an LLM was adapted to predict if a device profile is actually anomalous based on examples of anomalous and non-anomalous device profiles that were provided to the LLM with few-shot prompting. Devices corresponding to profiles that the LLM predicts are anomalous are flagged for further investigation and/or remediation.

### BACKGROUND

The disclosure generally relates to computing arrangements based on specific computational models (e.g., CPC subclass G06N) and to data processing (e.g., CPC subclass G06F).

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large language models (LLMs) are based on the Transformer architecture. An LLM is “large” because the training parameters are typically in the billions. LLMs can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model.

Natural language processing (NLP) is a field dedicated to the study of computer interpretation of natural languages. This can take the form of speech recognition, text classification, and text-to-speech translation, among other examples. For text classification, documents are parsed for string tokens, and string tokens are converted to embedded numerical feature vectors. These embeddings that map parsed strings to numerical space preserve semantic similarity between strings in the resulting numerical space. Text embeddings that are closer to each other in an N-dimensional vector space are generally closer in meaning (i.e., more semantically similar).

### BRIEF DESCRIPTION OF THE DRAWINGS

Embodiments of the disclosure may be better understood by referencing the accompanying drawings.

FIG. 1 is a conceptual diagram of detecting potentially anomalous device profiles and verifying anomalousness thereof for reduced false positive detections.

FIG. 2 is a flowchart of example operations for determining potentially anomalous devices based on clustering device profile embeddings.

FIG. 3 is a flowchart of example operations for generating dual embeddings of device profiles.

FIG. 4 is a flowchart of example operations for verifying anomalousness of potentially anomalous device profiles using a language model.

FIG. 5 is a flowchart of example operations for adapting a language model to determine whether device profiles indicated in prompts are anomalous.

FIG. 6 depicts an example computer system with an anomalous device detection service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

In the field of cybersecurity, anomaly detection techniques are employed to identify events, activities, and/or behavior patterns that deviate from those that are normal (i.e., expected to be observed). Anomalies may be attributable to security threats or other malicious activities. With reference to devices, detection of anomalous devices connected to a network is an integral part of identifying suspicious activity or potential threats in the network.

Disclosed herein are techniques for two-stage detection of anomalous devices in a network that includes verification of detected anomalies to reduce the incidence of false positive detections. An anomalous device detection service (hereinafter “the service”) first generates a dual embedding for each of a plurality of device profiles that comprise data/metadata of the respective devices. The dual embedding comprises a sentence embedding and a character-based (e.g., n-grams-based) embedding that have been combined (e.g., concatenated). Since the device data/metadata can comprise natural language and non-natural language features, the service generates the dual embeddings to capture both character-level patterns reflected in alphanumeric strings (e.g., device identifiers) and sentence-level semantics. The service clusters the generated embeddings into one or more clusters. From the resulting cluster(s), the service can identify outliers that correspond to potentially anomalous device profiles. The outliers are referred to as potentially anomalous at this stage because the service then verifies the verdicts of anomalousness resulting from clustering using an LLM that has been adapted to predict if a device profile is anomalous. The LLM was adapted to predict whether an input device profile is anomalous based on examples of anomalous and non-anomalous device profiles that were provided to the LLM, such as with few-shot prompting. The verification stage with the LLM is implemented to discern between device profiles that are anomalous and those that are true outliers that are not anomalous. Devices corresponding to profiles for which the LLM provides another anomalous verdict are identified as anomalous and can then be flagged for further investigation and/or remediation.

### Example Illustrations

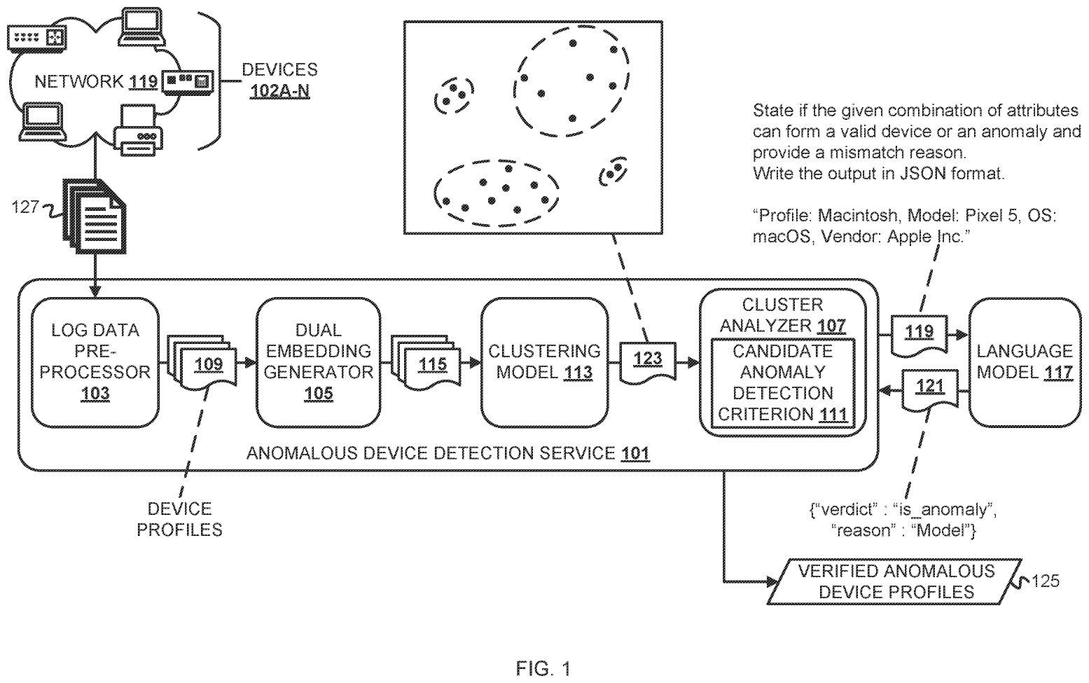

FIG. 1 is a conceptual diagram of detecting potentially anomalous device profiles and verifying anomalousness thereof for reduced false positive detections. FIG. 1 depicts an anomalous device detection service (“the service”) 101. The service 101 performs two-stage detection of anomalous devices connected to a network 119 for reduced false positive detection of anomalous devices. The service 101 can execute on a physical or virtual device/system (e.g., on a physical or cloud server). The service 101 obtains log data 127 for devices 102A-N of the network 119. The network 119 may be a local area network (LAN), wide area network (WAN), software-defined WAN (SD-WAN), etc. Log data 127 can comprise traffic log data collected by a cybersecurity appliance(s) (e.g., a firewall(s)) securing the network 119, endpoint log data collected by agents installed on respective ones of the devices 102A-N, or a combination thereof. Collection of the log data 127 may be via agents or other client-side software installed on the devices 102A-N and/or a cybersecurity appliance to which the devices 102A-N are connected (not depicted in FIG. 1). As another example, the service 101 can collect the log data 127 from a designated storage location (e.g., a storage location indicated in its configuration) or retrieve the log data 127 from input. Collection of the log data 127 can be based on a schedule or based on a trigger condition being met.

The service 101 comprises a log data preprocessor 103. The log data preprocessor 103 preprocesses the log data 127 to create device profiles 109 that represent the devices 102A-N. The device profiles 109 comprise data and/or metadata of the devices 102A-N. Examples of data/metadata that can be included in a device profile generated for a device include device identifier, profile identifier, vendor, model, operating system, Simple Network Management Protocol (SNMP) information, and accessed (e.g., downloaded and/or accessed via the Internet) applications. For instance, the log data preprocessor 103 can determine data and/or metadata of each of the devices 102A-N to include in device profiles (e.g., based on feature selection performed based on expert knowledge) and create the device profiles 109 from the determined data/metadata. The device profiles 109 can comprise a data structure(s) that stores the data/metadata of the respective device(s).

The service 101 comprises a dual embedding generator 105 that creates dual embeddings 115 based on the device profiles 109. The dual embedding generator 105 generates a dual embedding for each device profile that comprises a first embedding that captures character-level patterns and a second embedding that captures sentence-level semantics since device profiles can comprise both due to the presence of natural language features and non-natural language features (e.g., alphanumeric strings, such as identifiers) therein. In this example, the dual embedding generator 105 comprises embedding models that create respective character-based and sentence embeddings based on input text. For instance, the dual embedding generator 105 can comprise a character-based embedding model and a sentence transformer. As an example, the character-based embedding model may comprise a convolutional neural network (CNN) and/or an autoencoder. The dual embedding generator 105 may further determine n-grams of the text of each of the device profiles 109 and create the character-level embeddings from the n-grams, such as by inputting the n-grams into the character-based embedding model. The embedding models utilized by the dual embedding generator 105 can be off-the-shelf embedding models (e.g., open-source libraries) or may be proprietary.

If the device profiles 109 are not already in a text format that can be processed by an embedding model, the dual embedding generator 105 or an input layer/interface thereof may convert each of the device profiles 109 to a text string before inputting the device profiles 109 into each of the embedding models. The dual embedding generator 105 creates a dual embedding comprising a character-based embedding and a sentence embedding for each of the device profiles 109 and, for each resulting character-based embedding and sentence embedding corresponding to a device profile, combines (e.g., concatenates) the character-based embedding and sentence embedding to produce a respective one of the dual embeddings 115. Each of the dual embeddings 115 thus corresponds to one of the device profiles 109 and comprises combined character-based and sentence embeddings generated from the device profile. The dual embeddings 115 may be labelled, tagged, etc. with an indication of the corresponding one of the device profiles 109 to aid in identifying the device profile that the respective embedding represents.

To illustrate, consider an example device profile for a Samsung Galaxy® device with an Android™ operating system represented by the text string “Profile:Samsung Galaxy, Model:sm-g986u, OS:Android, Vendor:Samsung”. The dual embedding generator 105 can create a character-based embedding from this profile by determining n-grams of the text string and input the n-grams of the text string into an embedding model that accepts n-grams as input. The dual embedding generator 105 can also remove the keys/attribute names in the key-value pairs of which the device profile is comprised and/or remove special characters (e.g., spaces, separators, etc.) before generating the dual embedding. This can be performed as part of converting a device profile to a text string. As an example, when the character-based embedding is created using 3-grams, the dual embedding generator 105 creates 3-grams from the device profile text represented as “Sam, ams, msu, sun, ung, ngG, Gal, . . . , msu, sun, ung” and inputs these 3-grams into the character-based embedding model. The dual embedding generator 105 can create a sentence embedding from this profile by regarding the full text string as a sentence and inputting this “sentence” (i.e., the full text string) into a sentence transformer. The dual embedding generator 105 then combines the resulting n-grams based embedding and sentence embedding by concatenating the resulting embeddings, which yields the dual embedding for this profile.

The dual embeddings 115 are passed as input into the clustering model 113 for clustering. The clustering model 113 utilizes unsupervised learning to cluster dual embeddings representing device profiles into clusters. For instance, the clustering model 113 may cluster the dual embeddings 115 using HDBSCAN. The clustering model 113 may have been preconfigured to ignore/disregard a label, tag, etc. that indicates the device profile to which each of the dual embeddings 115 corresponds during clustering. The clustering model 113 clusters the dual embeddings 115 into a plurality of clusters and outputs cluster data 123. The cluster data 123 comprise indications of cluster memberships for the dual embeddings 115. The cluster data 123 can also indicate additional cluster metrics, such as cluster statistics, the probability or confidence that each of the dual embeddings 115 is a member of its respective cluster, outlier scores indicating the likelihood that each of the dual embeddings 115 is an outlier with respect to its cluster (if provided by the clustering algorithm), etc. The cluster data 123 can also indicate the labels, tags, etc. indicating the device profiles 109 to aid in discerning cluster membership of the device profiles 109.

The cluster analyzer 107 obtains and analyzes the cluster data 123 based on a candidate anomaly detection criterion (“criterion”) 111. The criterion 111 indicates a criterion for identifying device profiles as anomalous device profile candidates based on analysis of clustered dual embeddings representing device profiles. For instance, the criterion 111 can indicate a probability/confidence and/or outlier score threshold(s) based on which the cluster analyzer 107 evaluates probability/confidence values and/or outlier scores associated with each of the device profiles 109 in the cluster data 123. The cluster analyzer 107 identifies those of the device profiles 109 corresponding to dual embeddings for which the probability of cluster membership is sufficiently low and/or the outlier score is sufficiently high (e.g., is below a threshold and exceeds a threshold, respectively) as outliers and thus as anomalous device profile candidates. The cluster analyzer 107 determines the device profiles 109 associated with the outlier dual embeddings identified in the cluster data 123 based on the corresponding label(s), tag(s), etc.

The service 101 verifies anomalousness of the outliers that correspond to anomalous device profile candidates using a language model 117. The language model 117 may be a pre-trained Transformer-based LLM. The language model 117 is depicted separately from the components of the service 101 (i.e., the log data preprocessor 103, dual embedding generator 105, etc.) because the service 101 may submit prompts to and receive responses from the language model 117 via an application programming interface (API) thereof. The language model 117 has been adapted to discern whether a device profile indicated in a prompt is anomalous or non-anomalous (i.e., normal). Adapting the language model 117 for this task may be achieved through prompt engineering and few-shot prompting or fine-tuning in which the language model 117 was provided examples of known anomalous and non-anomalous device profiles. The examples of known anomalous and non-anomalous device profiles may have been gathered from prior observation and/or created based on expert knowledge.

To verify anomalousness of the outliers identified from clustering, the service 101 constructs prompts 119 that correspond to the anomalous device profile candidates. Each of the prompts 119 comprises one or more task instructions and the respective device profile. The device profile may be included in the prompt in its text format created as part of dual embedding generation. FIG. 1 gives an example one of the prompts 119 as comprising the task instructions, “State if the given combination of attributes can form a valid device or an anomaly and provide a mismatch reason. Write the output in JSON format.” The mismatch reason is the one or more device attributes identified in a device profile that are the reason for the language model's verdict if the device is determined to be anomalous. The service 101 obtains responses 121 to the prompts 119 that indicate whether the device profile indicated therein is anomalous. FIG. 1 depicts an example one of the prompts 119 that the service constructed for a device profile created for an Apple® device running macOS® that is a Google Pixel™ model with the text string “Profile: Macintosh, Model: Pixel 5, OS: macOS, Vendor: Apple Inc.” The one of the responses 121 provided by the language model 117 for this prompt comprises the example JavaScript® Object Notation (JSON) attribute/value pairs “{“verdict”: “is_anomaly”, “reason”: “Model”}”. The device profile was thus identified as an anomaly because the model is inconsistent with its other attributes (i.e., Google Pixel is not a model of an Apple device that uses the MacOS operating system).

For those of the responses 121 indicating that the corresponding one of the device profiles 109 is anomalous, the service 101 adds the device profile to a set of verified anomalous device profiles 125. The verified anomalous device profiles 125 comprise those of the device profiles 109 that were both identified as outliers at the clustering stage of anomaly detection by the cluster analyzer 107 and verified as anomalous by the language model 117. Those of the device profiles 109 that the language model 117 indicates are not anomalous can thus be effectively filtered out from anomaly detection, which reduces false positive detections. The service 101 indicates the verified anomalous device profiles 125, such as by generating a notification or report that identifies the verified anomalous device profiles 125, so that the corresponding ones of the devices 102A-N can be addressed accordingly (e.g., by quarantining the devices, flagging the devices for investigation or remediation, etc.).

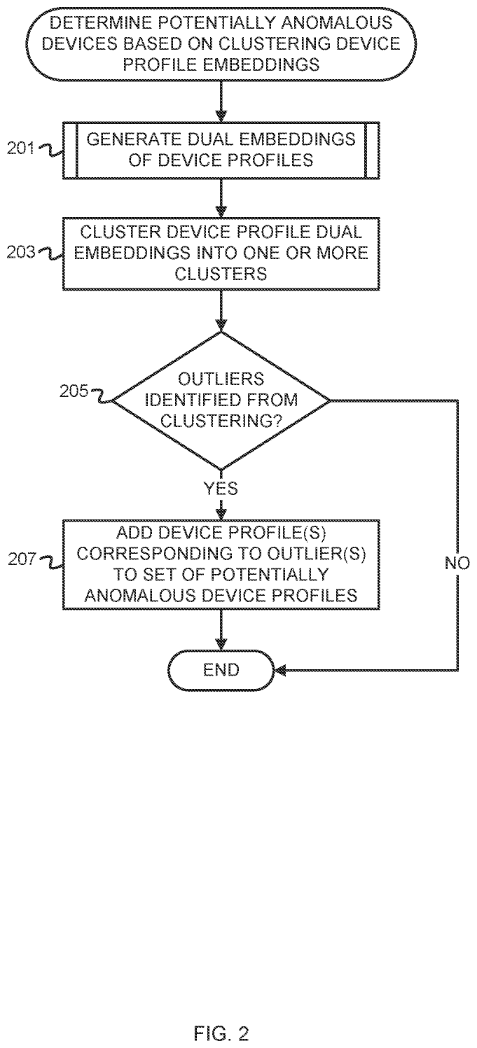

FIGS. 2-5 are flowcharts of example operations. The example operations are described with reference to an anomalous device detection service (hereinafter “the detection service” for brevity) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for determining potentially anomalous devices based on clustering device profile embeddings. The example operations assume that profiles of devices have been created that comprise data and/or metadata of devices in a network (e.g., in a LAN, WAN, SD-WAN, etc.).

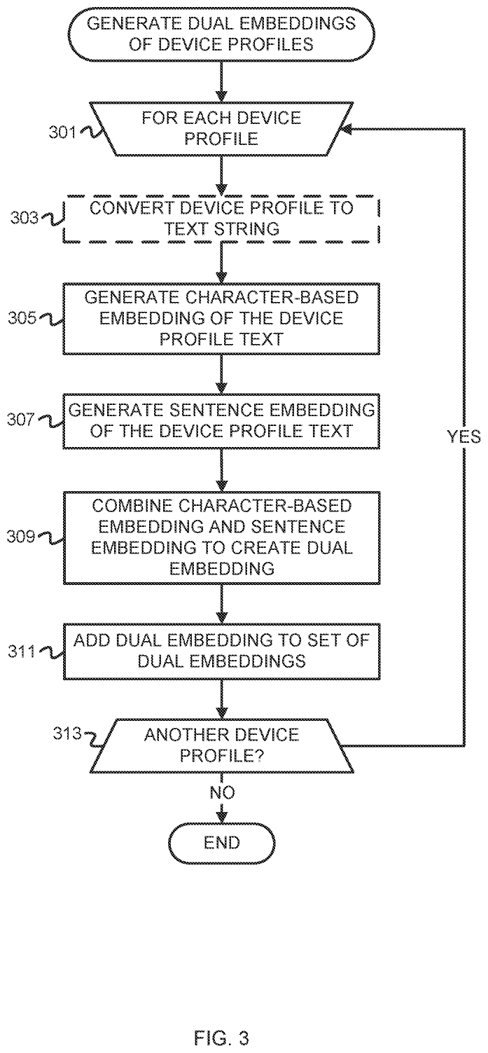

At block 201, the detection service generates dual embeddings of device profiles. The detection service may first convert the device profiles to text strings before generating the dual embeddings if the device profiles are not already in textual format. Each of the dual embeddings comprises combined character-based and sentence embeddings generated from the text of a respective device profile. Generation of the dual embeddings can also be referred to generation of combined feature vectors, where the combined feature vector comprises a first feature vector produced by a character-based embedding model and a second feature vector produced by a sentence embedding model. Generation of dual embeddings is described in further detail in reference to FIG. 3.

At block 203, the detection service clusters the device profile dual embeddings into one or more clusters. The detection service clusters the dual embeddings according to a clustering algorithm. Examples of clustering algorithms used for clustering dual embeddings include DBSCAN and HDBSCAN. The cluster size or number of clusters used as inputs to the clustering algorithm may be selected based on expert knowledge and/or based on prior experimentation and observation.

At block 205, the detection service determines if one or more outliers were identified from the clustering. Detection of outliers from the clusters can be based on one or more criteria for outlier detection. For some clustering algorithms, such as HDBSCAN, each data point corresponding to a device profile dual embedding may be associated with a score and/or probability indicating the likelihood that the data point is an outlier with respect to its cluster membership. The detection service can evaluate these scores and/or probabilities based on the criterion (a) to determine whether any are indicative that the respective data point is an outlier, such as based on whether any outlier scores exceed a threshold. In other examples, the detection service determines whether any of the data points corresponding to dual embeddings are a distance from their cluster centroid that exceeds a distance threshold determined based on cluster statistics (e.g., standard deviation of distance of data points from their respective centroid) and thus can be classified as outliers. If any of the clustered dual embeddings satisfy an outlier detection criterion, operations continue at block 207. Otherwise, operations are complete.

At block 207, the detection service adds the device profile(s) corresponding to the outlier(s) to a set of potentially anomalous device profiles. The detection service can identify the device profile associated with each detected outlier based on a label, tag, etc. that was associated with each dual embedding that was clustered. The set of potentially anomalous device profiles may be a data structure (e.g., a list) that comprises the potentially anomalous device profiles.

FIG. 3 is a flowchart of example operations for generating dual embeddings of device profiles. The example operations may implement block 201 of FIG. 2.

At block 301, the detection service begins iterating over the device profiles. The device profiles may be stored in one or more data structures, in a file(s), etc.

At block 303, the detection service converts the device profile to a text string. Block 303 is depicted with dashed lines since device profiles can comprise text stored in documents (e.g., in a file(s)) and thus are already in text format. Conversion of the device profile to a text string yields a textual format of the device profile. The detection service can use a library or built-in function that converts data structures to text to convert the device profile to a text string, for example. The detection service may also remove keys/attribute names in key-value pairs of which the device profile is comprised and/or special characters (e.g., spaces and/or separators) as part of generating the text string.

At block 305, the detection service generates a character-based embedding of the device profile text. The detection service utilizes a character-based embedding model to generate the character-based embedding. The character-based embedding model may be provided as an off-the-shelf and/or open-source library. For instance, the detection service can generate the embedding with a CNN-based autoencoder. Further, the detection service can determine n-grams (e.g., 3-grams, 4-grams, etc.) of the device profile text and create an embedding from the resulting n-grams. The value of n can be a preconfigured value of the detection service.

At block 307, the detection service generates a sentence embedding of the device profile text. The detection service utilizes a sentence embedding model to generate the sentence embedding. For instance, the detection service can generate the embedding with a sentence transformer, such as a sentence transformer based on the Bidirectional Encoder Representations from Transformers (BERT) model. The sentence embedding model may also be provided as an off-the-shelf and/or open-source library.

At block 309, the detection service combines the character-based embedding and the sentence embedding to create a dual embedding. The detection service can normalize the embeddings before combining the embeddings, such as by padding each embedding so it reaches a predetermined size/length (e.g., by padding with zeros), and combining the normalized embeddings. The detection service can combine the embeddings through concatenation to yield a dual embedding that comprises the character-based embedding and the sentence embedding.

At block 311, the detection service adds the dual embedding to a set of dual embeddings. The set of dual embeddings may be maintained in a data structure, in a file, etc.

At block 313, the detection service determines if there is another device profile. If there is another device profile, operations continue at block 301. Otherwise, operations are complete.

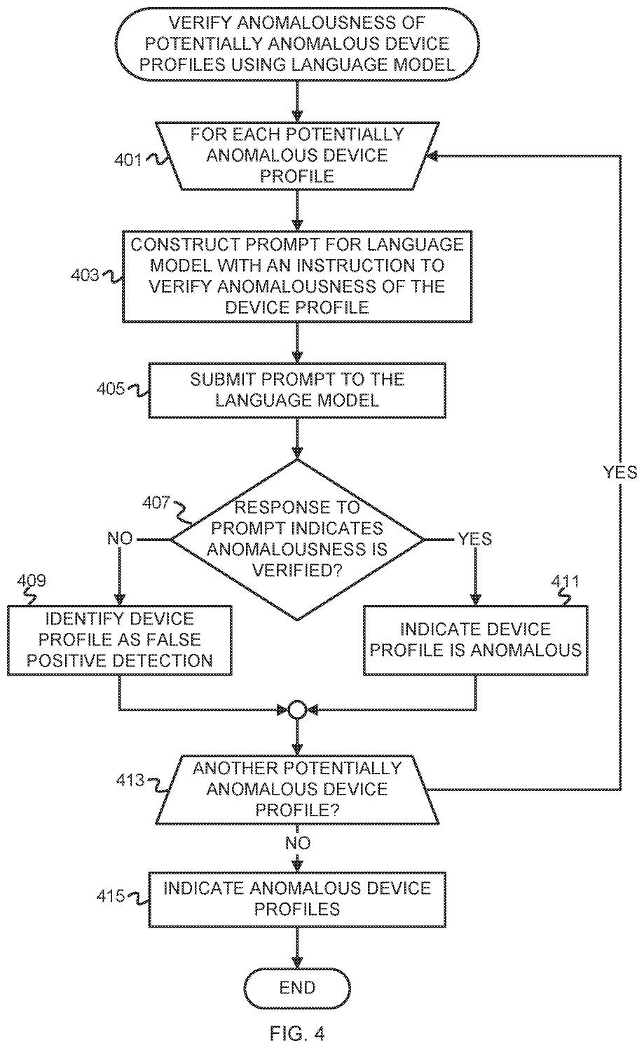

FIG. 4 is a flowchart of example operations for verifying anomalousness of potentially anomalous device profiles using a language model. The language model with which the detection service verifies anomalousness of potentially anomalous device profiles can be an LLM, such as a pre-trained Transformer-based LLM. The language model was previously adapted to discern between anomalous and non-anomalous device profiles, such as based on few-shot prompting, fine-tuning, etc. with examples of anomalous and non-anomalous device profiles. The known anomalous and non-anomalous device profiles were gathered from prior observation and detection and/or constructed based on expert/domain knowledge.

At block 401, the detection service begins iterating over each potentially anomalous device profile. The example operations assume that one or more device profiles have been identified as potentially anomalous as a result of clustering as described above.

At block 403, the detection service constructs a prompt for the language model with at least a first task instruction to determine if the device profile is anomalous. The constructed prompt comprises the device profile data/metadata and an instruction to state whether the device profile is anomalous. The constructed prompt may include additional instructions, such as an instruction to provide the response in a given format (e.g., JSON) and/or an instruction to provide the reason that the device profile is anomalous if the verdict is that the device profile is indeed anomalous. The detection service constructs the prompt according to a format that was used when adapting the language model for the task of verifying device profile anomalousness.

At block 405, the detection service submits the prompt to the language model. A response to the prompt obtained from the language model will indicate whether the device profile is anomalous.

At block 407, the detection service determines if the response to the prompt indicates that anomalousness of the device profile is verified. Anomalousness of the device profile is verified if the response indicates that the device profile is indeed anomalous. If the response to the prompt indicates that the device profile is non-anomalous (i.e., normal), operations continue at block 409. If the response to the prompt indicates that anomalousness is verified, operations continue at block 411.

At block 409, the detection service identifies the device profile as a false positive detection. For instance, the detection service can remove the device profile from the set of potentially anomalous device profiles or associate a flag, label, etc. with the device profile indicating that it is a false positive detection.

At block 411, the detection service indicates the device profile is anomalous. For instance, the detection service can add the device profile to a set of verified anomalous device profiles or associate a flag, label, etc. with the device profile in the set of potentially anomalous device profiles. The detection service can include any additional information provided in the response in the indication that the device profile is anomalous, such as the reason for the anomalous verdict.

At block 413, the detection service determines if there is another potentially anomalous device profile. If so, operations continue at block 401. Otherwise, operations continue at block 415.

At block 415, the detection service indicates the anomalous device profiles. The detection service at least indicates those of the potentially anomalous device profiles that were verified to be anomalous. Indicating the anomalous device profiles can include generating a report or notification indicating the anomalous device profiles, storing indications of the anomalous device profiles in a database, etc.

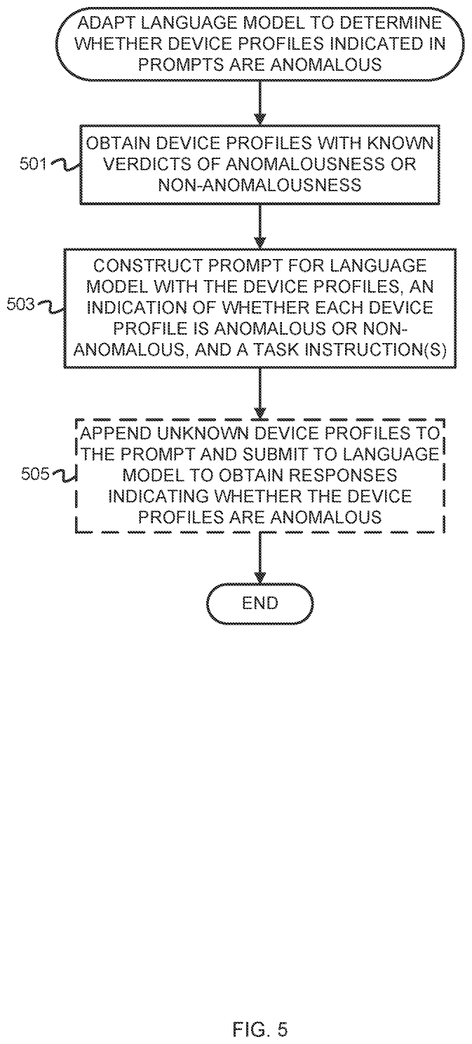

FIG. 5 is a flowchart of example operations for adapting a language model to determine whether device profiles indicated in prompts are anomalous. As described above, the language model can be an LLM. While the example operations refer to using few-shot prompting to adapt the language model for the task of determining whether device profiles are anomalous, other techniques for adapting a language model for this task, such as fine-tuning, can be utilized in implementations. The example operations also are described as being performed by the detection service, though other entities can adapt the language model before it is deployed to interface with the detection service.

At block 501, the detection service obtains device profiles with known verdicts. The set of device profiles with known verdicts can comprise device profiles known to be anomalous and those known to be normal (i.e., non-anomalous) and thus correspond to known anomalous or non-anomalous devices. These device profiles may have been identified from prior observation and detection of anomalous devices and/or crafted based on expert/domain knowledge.

At block 503, the detection service constructs a prompt for the language model with the device profiles, an indication of whether each device profile is anomalous or non-anomalous, and one or more task instructions. The constructed prompt includes the attributes of each of the devices included in the device profiles and the corresponding verdicts. The prompt may include additional information about why each of the device profiles is anomalous or non-anomalous, such as an indication of the one or more attributes that are the reason for the verdict. Attributes that are the reason for the verdict are often those that are inconsistent with the rest of the device profile or result in the combination of attributes representing an invalid device. As an example, for a known anomalous device profile, an operating system may be the reason for the anomalous verdict if the device model and vendor do not possibly use that operating system. These attributes can be considered to be a mismatch from the rest of the profile. The prompt also comprises one or more task instructions for the language model to determine anomalousness of a device profile with an unknown verdict. The task instructions may indicate an additional instruction(s) that the response be provided in a designated format (e.g., JSON) and/or that the language model identify the attribute(s) that are the reason for the verdict.

At block 505, the detection service appends unknown device profiles to the prompt and submits the prompt to the language model to obtain responses indicating whether the device profiles are anomalous. The prompt constructed at block 503 thus serves as a prompt template for generating prompts that are submitted to the language model. Block 505 is depicted in dashed lines because submission of the prompt with the unknown device profiles appended thereto is ongoing as the detection service identifies outliers as a result of clustering as described above. The language model thus learns from the examples of device profiles with known verdicts provided in the prompt and determines whether the unknown device profile for which a verdict is requested is anomalous.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, with reference to FIG. 3, the operation depicted in block 303 can be performed in parallel or concurrently across device profiles depending on the format of the device profiles. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

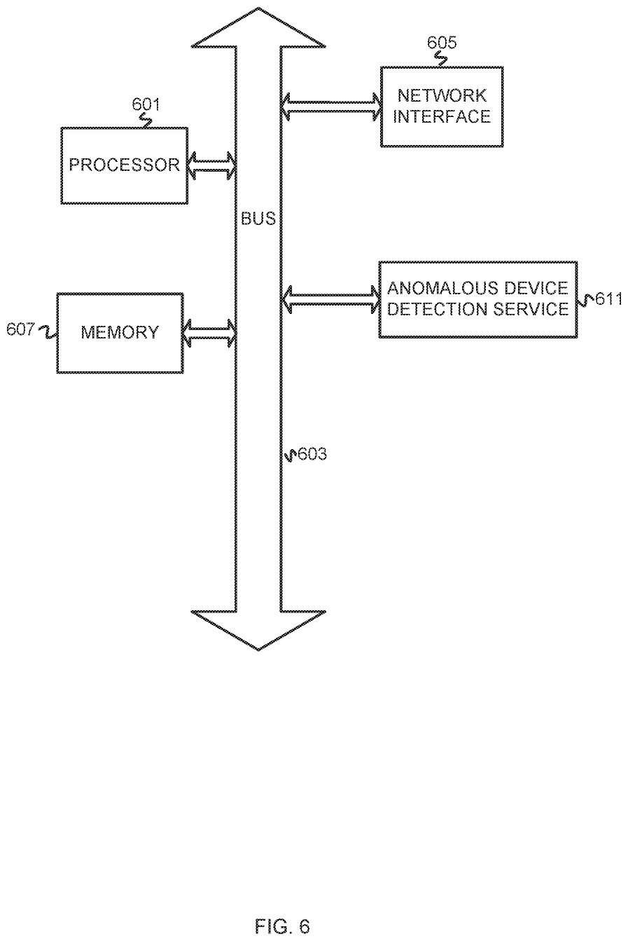

FIG. 6 depicts an example computer system with an anomalous device detection service. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes anomalous device detection service 611. The anomalous device detection service 611 detects anomalous devices based on clustering device profiles and verifies that the outliers are actually anomalous using a language model adapted to discern whether a device profile is anomalous. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
generating a plurality of embeddings representing a plurality of device profiles, wherein each of the plurality of device profiles comprises at least one of data and metadata collected for a corresponding device in a network;
clustering the plurality of embeddings into one or more clusters;
identifying a subset of the plurality of device profiles as anomalous device profiles based on analyzing the one or more clusters;
prompting a language model to verify anomalousness of the subset of device profiles; and
based on verifying anomalousness of one or more device profiles of the subset of device profiles, indicating that the one or more device profiles are anomalous.

2. The method of claim 1, wherein prompting the language model to verify anomalousness of the subset of device profiles comprises generating a set of prompts corresponding to the subset of device profiles for the language model and submitting each prompt of the set of prompts to the language model.

3. The method of claim 2 further comprising obtaining responses to submitting the set of prompts to the language model that indicate whether corresponding ones of the subset of device profiles are anomalous, wherein verifying anomalousness of the one or more device profiles comprises determining that one or more of the responses indicate that the corresponding one or more device profiles are anomalous.

4. The method of claim 1, wherein the plurality of embeddings comprises a plurality of dual embeddings, and wherein generating the plurality of dual embeddings comprises, for each device profile of the plurality of device profiles,
generating a sentence embedding from the device profile;
generating a character-based embedding from the device profile; and
combining the sentence embedding and the character-based embedding to generate a dual embedding.

5. The method of claim 4 further comprising converting the device profile to text, wherein generating the sentence embedding comprises generating the sentence embedding from the text of the device profile, and wherein generating the character-based embedding comprises determining n-grams of the text of the device profile and generating the character-based embedding from the n-grams of the text of the device profile.

6. The method of claim 1, wherein identifying the subset of device profiles as anomalous device profiles comprises, based on analyzing the one or more clusters, determining that a corresponding subset of the plurality of embeddings are outliers in the one or more clusters.

7. The method of claim 1, wherein clustering the plurality of embeddings into the one or more clusters comprises clustering the plurality of embeddings according to a clustering algorithm, wherein the clustering algorithm comprises DBSCAN or HDBSCAN.

8. The method of claim 1, wherein the language model was previously adapted to predict whether device profiles indicated in prompts are anomalous based on few shot prompting with sets of known anomalous device profiles and known non-anomalous device profiles.

9. The method of claim 1, wherein the language model comprises a pre-trained Transformer-based large language model (LLM).

10. One or more non-transitory machine-readable media having program code stored thereon, the program code comprising instructions to:
generate a plurality of feature vectors representing a plurality of device profiles, wherein each of the plurality of device profiles comprises at least one of data and metadata collected for a corresponding device in a network;
cluster the plurality of feature vectors into one or more clusters;
determine whether any of the plurality of device profiles are potentially anomalous based on analysis of the one or more clusters;
based on a determination that one or more device profiles of the plurality of device profiles are potentially anomalous, prompt a language model to verify whether each of the one or more device profiles is anomalous; and
based on verification of a first device profile of the one or more device profiles as anomalous, indicate that the first device profile is anomalous.

11. The non-transitory machine-readable media of claim 10, wherein the instructions to generate the plurality of feature vectors comprises, for each device profile of the plurality of device profiles, convert the device profile to a text string;
generate a sentence vector of the text string of the device profile;
generate a character-based vector of the text string of the device profile; and
combine the sentence vector and the character-based vector.

12. The non-transitory machine-readable media of claim 11, wherein the instructions to generate the character-based vector comprise instructions to determine n-grams of the text string of the device profile and generate the character-based vector from the n-grams of the text string.

13. The non-transitory machine-readable media of claim 10, wherein the instructions to prompt the language model to verify whether each of the one or more device profiles is anomalous comprise instructions to generate one or more prompts corresponding to the one or more device profiles for the language model and submit each of the one or more prompts to the language model.

14. The non-transitory machine-readable media of claim 13, wherein the program code further comprises instructions to obtain responses to the one or more prompts to the language model that indicate whether corresponding ones of the one or more device profiles are anomalous, wherein verification of the first device profile as anomalous is based on a determination that a corresponding one of the responses indicates that the first device profile is anomalous.

15. An apparatus comprising:
a processor; and
a machine-readable medium having instructions stored thereon that are executable by the processor to cause the apparatus to,
generate a plurality of embeddings representing a plurality of device profiles, wherein each of the plurality of device profiles comprises at least one of data and metadata collected for a corresponding device in a network;
cluster the plurality of embeddings into a plurality of clusters;
based on analysis of the plurality of clusters, determine that a subset of the plurality of device profiles are anomalous device profile candidates;
prompt a language model to verify anomalousness of each device profile of the anomalous device profile candidates; and
based on verification of anomalousness of one or more device profiles of the candidate anomalous device profiles, indicate that the one or more device profiles are anomalous.

16. The apparatus of claim 15, wherein the instructions executable by the processor to cause the apparatus to generate the plurality of embeddings comprise instructions executable by the processor to cause the apparatus to, for each device profile of the plurality of device profiles,
generate a sentence embedding from the device profile;
generate a character-based embedding from the device profile; and
combine the sentence embedding and the character-based embedding.

17. The apparatus of claim 16, further comprising instructions executable by the processor to cause the apparatus to convert the device profile to text,
wherein the instructions executable by the processor to cause the apparatus to generate the sentence embedding comprise instructions executable by the processor to cause the apparatus to generate the sentence embedding from the text of the device profile, and
wherein the instructions executable by the processor to cause the apparatus to generate the character-based embedding comprise instructions executable by the processor to cause the apparatus to determine n-grams of the text of the device profile and generate the character-based embedding from the n-grams of the text of the device profile.

18. The apparatus of claim 15, wherein the instructions executable by the processor to cause the apparatus to prompt the language model to verify anomalousness of each device profile of the anomalous device profile candidates comprise instructions executable by the processor to cause the apparatus to generate a set of prompts corresponding to the anomalous device profile candidates for the language model and submit each prompt of the set of prompts to the language model, wherein the language model was previously adapted to predict whether device profiles indicated in prompts are anomalous.

19. The apparatus of claim 15, wherein the instructions executable by the processor to cause the apparatus to determine that the subset of the plurality of device profiles are anomalous device profile candidates comprise instructions executable by the processor to cause the apparatus to, based on analysis of the plurality of clusters, determine that a corresponding subset of the plurality of embeddings are outliers in the plurality of clusters.

20. The apparatus of claim 15, wherein the instructions executable by the processor to cause the apparatus to cluster the plurality of embeddings into the plurality of clusters comprise the instructions executable by the processor to cause the apparatus to cluster the plurality of embeddings according to a clustering algorithm, wherein the clustering algorithm comprises DBSCAN or HDBSCAN.
